(19) United States
(12) Patent Application Publication
(10) Pub. No.: US 2015/0288390 A1
(43) Pub. Date: Oct. 8, 2015

(54) RADIO MODULE AND METHOD OF MANUFACTURING THE SAME

(71) Applicant: Panasonic Intellectual Property Management Co., Ltd., Osaka (JP)

(72) Inventors: MAKI NAKAMURA, Osaka (JP); SUGURU FUJITA, Tokyo (JP)

(21) Appl. No.: 14/664,954

(22) Filed: Mar. 23, 2015

(30) Foreign Application Priority Data
Apr. 2, 2014 (JP) 2014-076269

(51) Int. Cl. H04B 1/03

(52) U.S. Cl. CPC H04B 1/03

(57) ABSTRACT

There is provided a radio module including: a first substrate; a second substrate that has a side which is opposed to the first substrate and on which an electronic component is mounted; a conductive member that connects the first substrate and the second substrate and that transmits a signal between the first substrate and the second; at least one first pad that is disposed in the first substrate and connected to the conductive member; and at least one second pad that is disposed in the second substrate and connected to the conductive member, each of the at least one second pad being opposed to each of the at least one first pad and each of larger than the at least one first pad in area.

### BACKGROUND

1. Technical Field

The present disclosure relates to a radio module and a method of manufacturing the radio module.

2. Description of the Related Art

As a method of producing a radio module in related art, for example, a high integration or miniaturization technique is known in which components to be mounted are built in between substrates. With this technique in related art, component embedding wireless modules are produced. In a radio module produced by the technique in related art, components are built in between two substrates and the two substrates are connected to each other by a conductive member, thereby achieving physical support and electrical connection of the substrates (see, for example, Japanese Unexamined Patent Application Publication No. 2008-153492).

### SUMMARY

With the technique disclosed in Japanese Unexamined Patent Application Publication No. 2008-153492, it is difficult to control a variation in disposed position of a conductive member with respect to a pad provided in a substrate of the radio module and to reduce the cost for the radio module.

One non-limiting and exemplary embodiment provides a radio module that enables a variation in disposed position of a conductive member to be controlled and manufacturing cost to be reduced, the disposed position being with respect to a corresponding pad provided in a substrate.

In one general aspect, the techniques disclosed here feature a radio module including: a first substrate; a second substrate that has a side which is opposed to the first substrate and on which an electronic component is mounted; a conductive member that connects the first substrate and the second substrate and that transmits a signal between the first substrate and the second; at least one first pad that is disposed in the first substrate and connected to the conductive member; and at least one second pad that is disposed in the second substrate and connected to the conductive member, each of the at least one second pad being opposed to each of the at least one first pad and larger than each of the at least one first pad in area.

According to the present disclosure, a variation in disposed position of a conductive member with respect to a corresponding pad provided in a substrate may be controlled and manufacturing cost may be reduced.

It should be noted that general or specific embodiments may be implemented as a system, a method, an integrated circuit, a computer program, a storage medium, or any selective combination thereof.

Additional benefits and advantages of the disclosed embodiments will become apparent from the specification and figures. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view illustrating a structural example of a radio module in a first embodiment;

FIG. 2 is a sectional view illustrating a first structural example of the radio module as seen in the direction of line II-II of FIG. 1;

FIG. 3A is a plan view illustrating an example of a first substrate and first pads of the radio module illustrated in FIG. 2;

FIG. 3B is a plan view illustrating an example of a second substrate and second pads of the radio module illustrated in FIG. 2;

FIG. 4 is a sectional view illustrating the relationship between the size of a ball and the height of a RFIC built in between substrates in the first embodiment;

FIG. 5A is an illustration for explaining radiation loss and copper loss due to radio wave leakage from a ball for signal in the first embodiment;

FIG. 5B is an illustration of an example of a narrow space between the ball for signal and balls for GND in the first embodiment;

FIG. 5C is an illustration of an example of a wide space between the ball for signal and balls for GND in the first embodiment;

FIG. 6 is a sectional view illustrating a second structural example of the radio module as seen in the direction of the line II-II of FIG. 1;

FIG. 7 is a sectional view illustrating a third structural example of the radio module as seen in the direction of the line II-II of FIG. 1;

FIG. 8A is a plan view illustrating an example of the first substrate and the first pads of the radio module illustrated in FIG. 7;

FIG. 8B is a plan view illustrating an example of the second substrate and the second pads of the radio module illustrated in FIG. 7;

FIG. 9A is a sectional view illustrating a structural example of a radio module in a second embodiment;

FIG. 9B is a plan view illustrating a second substrate as seen in +Z direction of FIG. 9A;

FIG. 10A is a sectional view illustrating a structural example of a radio module in a third embodiment;

FIG. 10B is a plan view illustrating the second substrate as seen in +Z direction of FIG. 10A in the third embodiment;

FIG. 10C is a translucent view of the second substrate with the GND of FIG. 10A exposed in the third embodiment;

FIG. 11A is a sectional view illustrating the structure of a radio module in which the same substrate is used irrespective of the size of balls;

FIG. 11B is a sectional view illustrating the structure of a radio module in which the same substrate is used irrespective of the size of balls and balls having a smaller diameter than in FIG. 11A are used;

FIG. 12A is a sectional view illustrating the structure of a radio module in which a different substrate is used according to the size of balls; and

FIG. 12B is a sectional view illustrating the structure of a radio module in which a different substrate is used according to the size of balls and balls having a smaller diameter than in FIG. 12A are used.

### DETAILED DESCRIPTION

Hereinafter, an embodiment of the present disclosure will be described with reference to the drawings.

### Underlying Knowledge Forming Basis of an Embodiment of the Present Disclosure

For example, a radio module used in a smart phone or a digital camera is demanded of higher integration or miniaturization. The functions demanded by customers are also diversified and radio modules (for example, a radio module including plural ICs (Integrated Circuit) and a radio module tailored to a single function), which cope with various needs, are on the market.

In order to prepare all individual radio modules for various needs, for example, the cost associated with design and management increases. For this reason, it is desirable that radio modules have a common structure as much as possible.

In the radio module described in Japanese Unexamined Patent Application Publication No. 2008-153492, balls having electrical conductivity are used to connect upper and lower substrates. The size (diameter) of the balls is determined depending on the height of electronic components (for example, an IC, a crystal oscillator mounted in the radio module). The height of electronic components may change when the type of build-in electronic components is changed according to the needs of customers.

The radio module in related art has the problem described below when electrically conductive balls with a size adjusted to the height of electronic components are used.

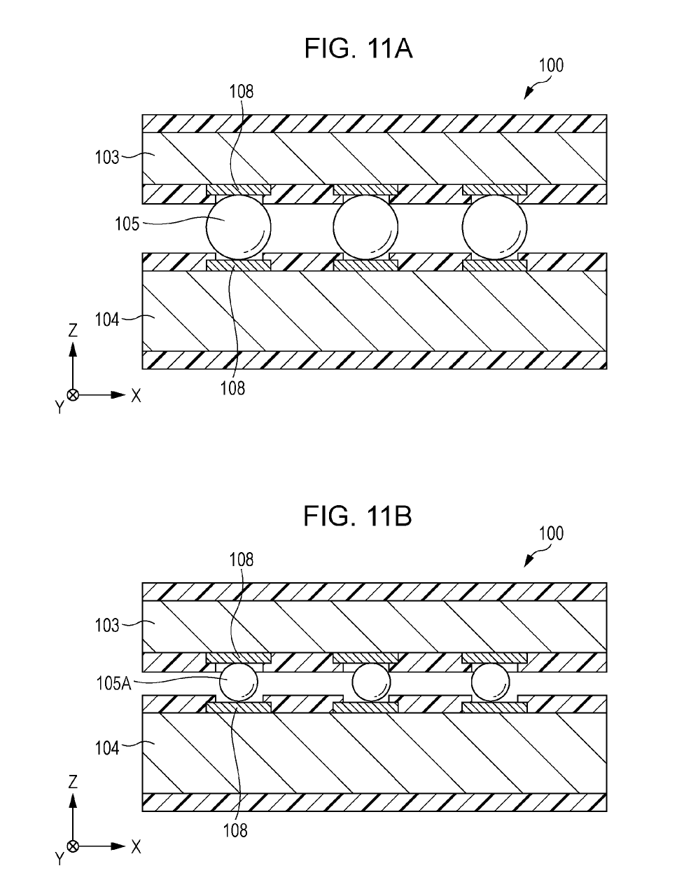

FIG. 11A is a sectional view illustrating the structure of a radio module 100 in which the same substrate is used irrespective of the size of balls and balls 105 are used. Because the height of built-in electronic components is high in FIG. 11A, the balls 105 are used. FIG. 11B is a sectional view illustrating the structure of the radio module 100 in which the same substrate is used irrespective of the size of balls and balls 105A having a smaller diameter than the balls 105 are used. Because the height of built-in electronic components is low in FIG. 11B, the balls 105A are used. In FIG. 11A and FIG. 11B, in order to receive the balls 105 and the balls 105A, pads 108 disposed in substrates 103, 104 have a size adjusted to the balls 105. In FIG. 11B, the size of the pads 108 is fixed. In the radio module of FIG. 11B, the balls 105A are received by the pads 108 with a size adjusted to the balls 105, and thus the disposed position of each ball 105A with respect to a corresponding pad 108 is not stable and is likely to have a variation.

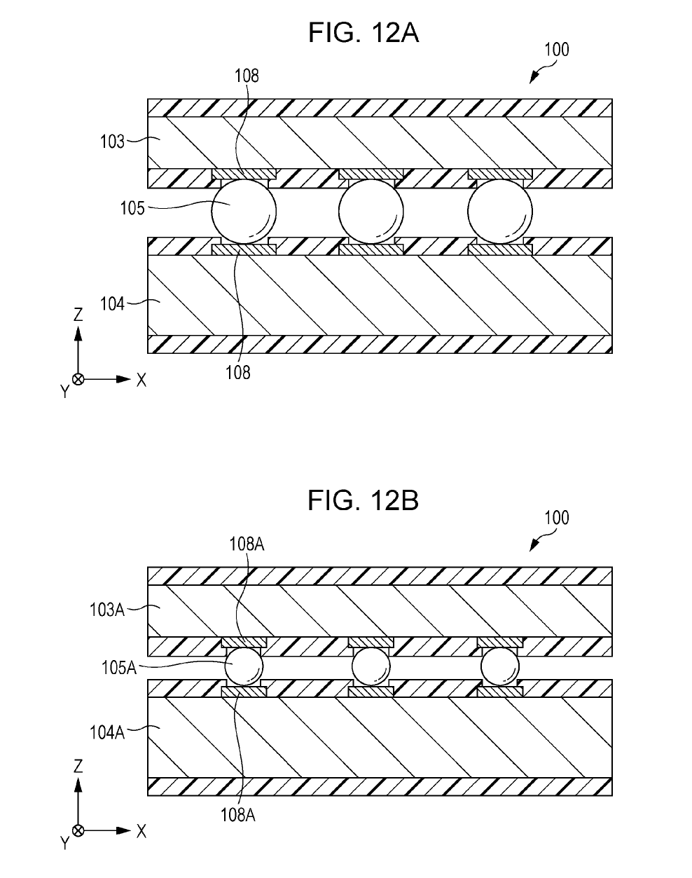

FIG. 12A is a sectional view illustrating the structure of the radio module 100 in which a different substrate is used according to the size of balls and the balls 105 are used. In FIG. 12A, the height of built-in electronic components is high and the pads 108 with a size adjusted to the balls 105 are disposed in the substrates 103, 104 in order to receive the balls 105. FIG. 12B is a sectional view illustrating the structure of the radio module 100 in which a different substrate is used according to the size of balls and the balls 105A having a smaller diameter than the balls 105 are used. In FIG. 12B, the height of built-in electronic components is low and pads 108A with a size adjusted to the balls 105A are disposed in substrates 103A, 104A in order to receive the balls 105A. In a radio module in related art, substrates having the pads 108, 108A with sizes adjusted to the sizes of the balls 105, 105A have to be prepared separately. Consequently, for example, the cost associated with design and management increases.

In the embodiments below, a radio module and a method of manufacturing the radio module will be described that enable a variation in disposed position of a conductive member to be controlled and manufacturing cost to be reduced, the disposed position being with respect to a corresponding pad provided in a substrate.

The radio module in the present embodiment is used as a radio module that includes, for example, an electronic component mounted between substrates and performs radio communication. The radio module is used for radio communication, for example, in a high frequency band (for example, a millimeter wave band (60 GHz as an example)). The radio module may be used for radio communication in a microwave band, for example.

### First Embodiment

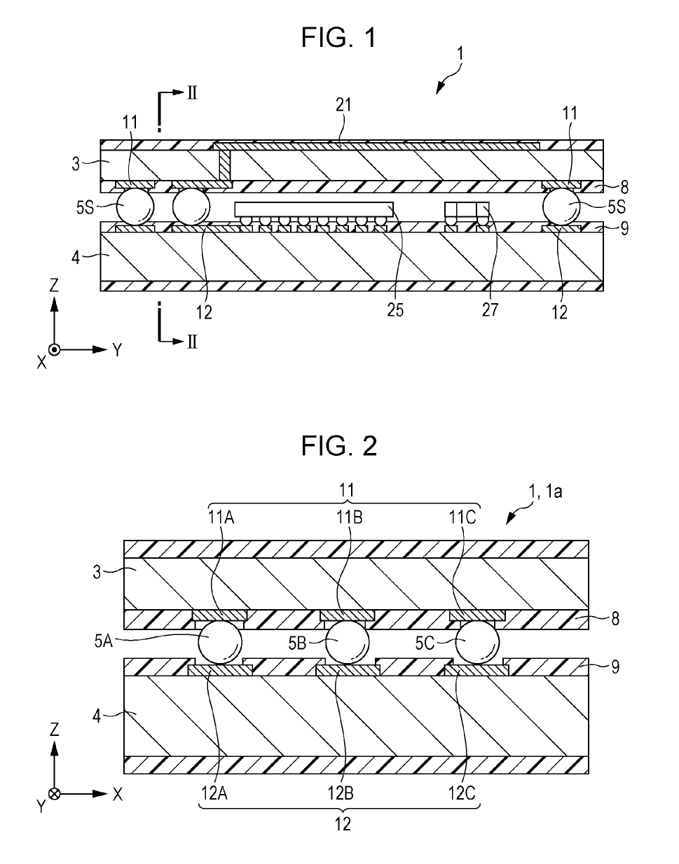

FIG. 1 is a sectional view illustrating a structural example of a radio module 1 in a first embodiment. In FIG. 1, the surfaces of substrates (a first substrate 3, a second substrate 4) are parallel to the X-Y plane, the right direction indicates the Y direction, and the direction to the near side in FIG. 1 indicates the X direction. Also, the direction perpendicular to the surface of each substrate, that is, the direction (upper direction) perpendicular to the X-Y plane is the Z direction.

The radio module 1 has a structure that combines a first substrate (upper substrate) 3 including an antenna 21 and a second substrate (lower substrate) 4 including electronic components. The electronic components include, for example, a radio frequency integrated circuit (RFIC) 25 and a crystal oscillator 27.

In the first substrate 3 and the second substrate 4, first pads 11 disposed in the first substrate 3 and second pads 12 disposed in the second substrate 4 are connected via balls 5S that are interposed between the first pads 11 and the second pads 12. The first substrate 3 and the second substrate 4 are electrically and physically connected via the balls 5S. Each of the balls 5S has electrical conductivity and is an example of a conductive member. It is to be noted that balls 5X (not illustrated) having a larger diameter than the balls 5S may be used according to the height of electronic components. The first pads 11 have a size adjusted to the balls 5S, and the second pads 12 have a size adjusted to the balls 5X.

Each of the balls 5S is, for example, a spherical conductive member disposed between the first substrate 3 and the second substrate 4, and comprises a metal (for example, copper or solder).

FIG. 2 is a sectional view illustrating a first structural example of the radio module 1(1a) as seen in the direction of the line II-II of FIG. 1. In FIG. 2, the ball 5S is used to connect the first substrate 3 and the second substrate 4.

The first pads 11 disposed in the first substrate 3 include a first pad 11B for signal, via which a signal (for example, a millimeter wave signal) is transmitted, and first pads 11A, 11C for GND adjacent to the first pad 11B. The first pads 11A, 11C for GND may be exposed at openings of a resist 8 which is applied to the first substrate 3.

The second pads 12 disposed in the second substrate 4 include a second pad 12B for signal, via which a signal is transmitted, and second pads 12A, 12C for GND adjacent to the second pad 12B. The second pads 12A, 12C for GND may be exposed at openings of a resist 9 which is applied to the second substrate 4.

In FIG. 2, the ball 5S includes, for an example, ball 5A, ball 5B, and ball 5C, the ball 5A connecting the first pad 11A and the second pad 12A, the ball 5B connecting the first pad 11B and the second pad 12B, the ball 5C connecting the first pad 11C and the second pad 12C.

The size of the first pads 11 disposed in the first substrate 3 is smaller than the size of the second pads 12 disposed in the second substrate 4. That is, the diameter of the first pads 11 is shorter than the diameter of the second pads 12. The first pads 11 and the second pads 12 are formed, for example, in a plate shape having a circular outline.

In FIG. 2, in the first substrate 3, any adjacent first pads 11 have an equal space therebetween. For example, the space (distance) between the adjacent first pad 11A and first pad 11B is approximately equal to the space between the first pad 11B and the first pad 11C.

In FIG. 2, in the second substrate 4, any adjacent second pads 12 have an equal space therebetween. For example, the space (distance) between the adjacent second pad 12A and second pad 12B is approximately equal to the space between the second pad 12B and the second pad 12C.

The first pads 11 are disposed so as to be opposed to the respective second pads 12. The center of each first pad 11 in the X direction is opposed to the center of a corresponding second pad 12 in the X direction. The first pads 11 are determined according to the size of the ball 5S. In FIG. 2, the first pads 11 are formed to be smaller than the second pads 12 according to the size of the ball 5S.

Therefore, in the radio module 1a, the position of each ball 5S in the X direction is determined by connecting the ball 5S to a corresponding first pad 11. Each ball 5S is connected to a corresponding second pad 12, and thereby is disposed at a position in the second pad 12, positioned by the connection. In FIG. 2, the ball 5S is disposed at the center of a corresponding second pad 12 in the X direction. Consequently, the disposed position of the ball 5S with respect to the corresponding first pad 11 and second pad 12 is determined by connecting the ball 5S to the first pad 11, thereby enabling a variation in the disposed position to be controlled.

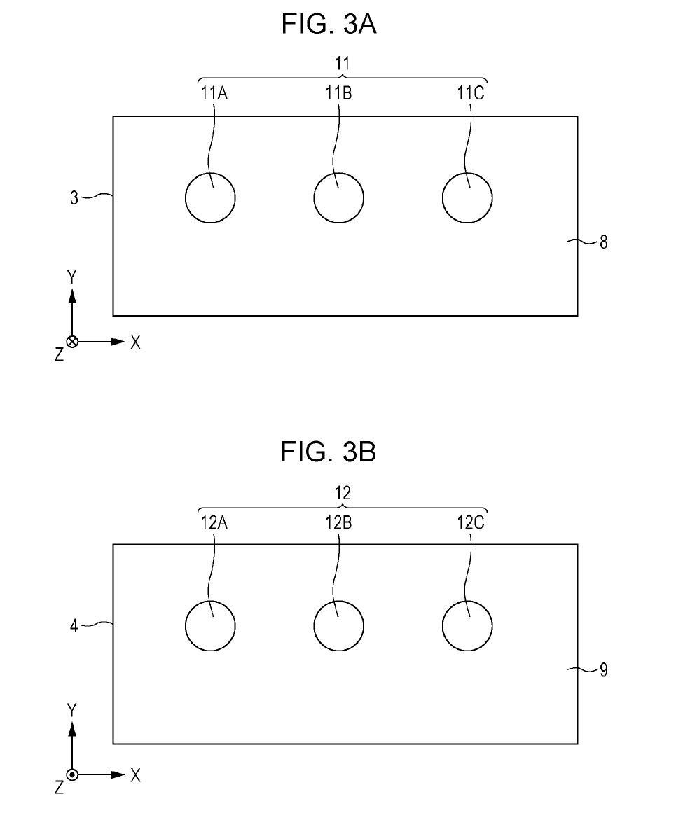

FIG. 3A is a plan view illustrating an example of the first substrate 3 and the first pads 11. FIG. 3A is a plan view of the first substrate 3 as seen from the lower side in FIG. 2, and the first pads 11 are disposed on +Z direction side of the first substrate 3. FIG. 3B is a plan view illustrating an example of the second substrate 4 and the second pads 12. FIG. 3B is a plan view of the second substrate 4 as seen from the upper side in FIG. 2, and the second pads 12 are disposed on −Z direction side of the second substrate 4.

In FIG. 3A, three first pads 11 are disposed in the first substrate 3. That is, in the first substrate 3, the first pad 11B for signal in the middle and the two first pads 11B, 11C for GND adjacent to the first pad 11B are disposed.

In FIG. 3B, three second pads 12 are disposed in the second substrate 4. That is, in the second substrate 4, the second pad 12B for signal in the middle and the two second pads 12B, 12C for GND adjacent to the second pad 12B are disposed.

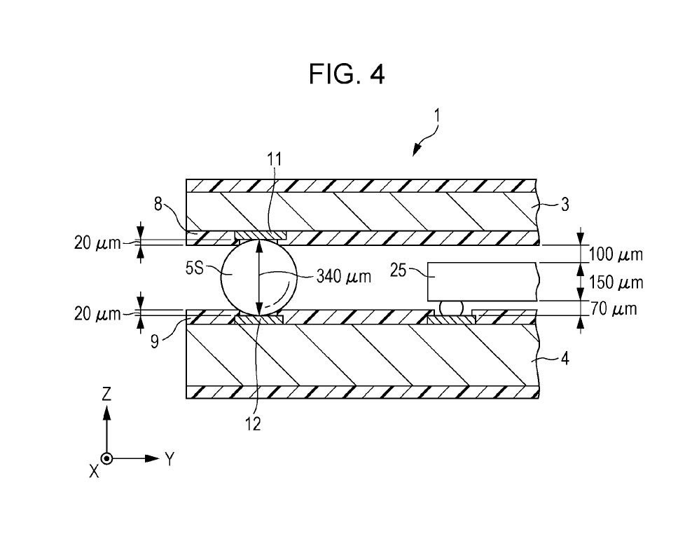

FIG. 4 is a sectional view illustrating the relationship between the size of the ball 5S and the height of the RFIC 25 built in between substrates. In FIG. 4, the radio module 1 has the following dimensions as an example: the height of the RFIC 25 which is built in as an electronic component is 150 μm, the height of solder bumps used for solder mounting is 70 μm, and the thickness of the resists 8, 9 which are applied onto the metal (for example, the first pads 11, the second pads 12) is 20 μm. In FIG. 4, the radio module 1 uses, as an example, the ball 5S having a diameter of 340 μm which is the sum of the height of the RFIC 25, the height of solder bumps, the thickness of the resists, and 100 μm as a margin.

Next, radiation loss and copper loss due to radio wave leakage from the ball 5B for signal will be described.

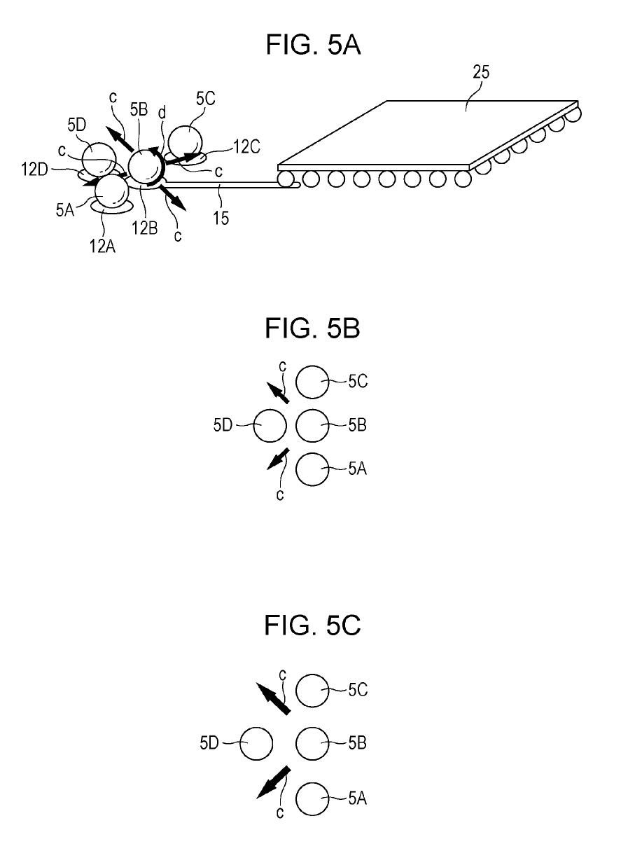

FIG. 5A is an illustration for explaining radiation loss and copper loss due to radio wave leakage from the ball 5B for signal. FIG. 5A illustrates an example of positional relationship between the ball 5B for signal, the balls 5A, 5C, 5D for GND, and the RFIC 25. FIG. 5B is an illustration of an example of a narrow space between the ball 5B for signal and the balls 5A, 5C, 5D for GND. FIG. 5C is an illustration of an example of a wide space between the ball 5B for signal and the balls 5A, 5C, 5D for GND.

The second pad 12B for signal is connected to a terminal of the RFIC 25 via a transmission line 15. Because the height of the RFIC 25 is low and the balls 5S are used in the radio module 1, the space between the ball 5B for signal via which a signal is transmitted and the balls 5A, 5C, 5D for GND may be narrowed as illustrated in FIG. 5B.

Accordingly, in FIG. 5A, the ball 5B for signal is surrounded by the balls 5A, 5C, 5D for GND, and thus radiation of radio waves (arrows c) due to transmission of signals through the ball 5B for signal may be controlled. Also, because the balls 5A to 5D have a small diameter, copper loss (arrow d) due to transmission of signals may be suppressed, and transmission loss may be reduced. In FIG. 5C, the space between the balls 5A to 5D is wider than in FIG. 5B, and longer length of arrow c indicates a larger amount of radio wave leakage.

For example, in the radio module 1, a signal outputted from the RFIC 25 is transmitted via the ball 5S in order to electrically propagate to the first substrate 3. When a signal to be transmitted is a high frequency signal (for example, a millimeter wave signal), the wavelength of the signal is on the order of mm. Thus, the size and/or the disposed position of the ball 5S is not negligible for the wavelength of the signal and affects the characteristics of transmission of signals from the RFIC 25 to the first substrate 3. That is, the radio module 1 using millimeter wave signals has high transmission loss (including, for example, radiation loss or copper loss), and so the transmission loss is suppressed by reducing the size (diameter) of the ball 5S as much as possible.

Therefore, the transmission loss may be reduced by using the ball 5S according to the height of electronic components in the radio module 1, and for example, when millimeter wave signals are utilized, the effect of reduction of transmission loss is further increased.

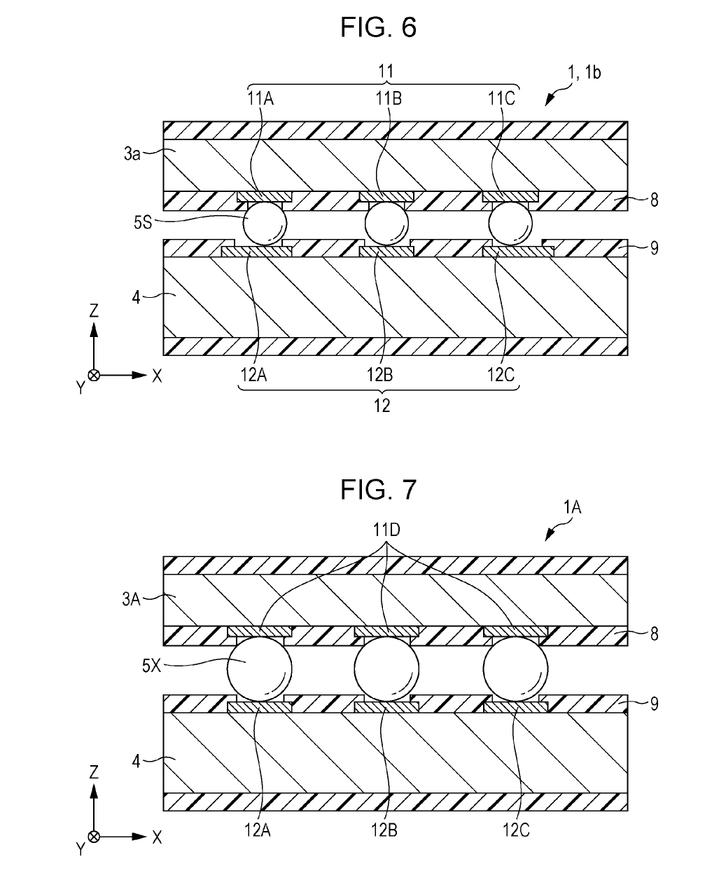

FIG. 6 is a sectional view illustrating a second structural example of the radio module 1 (1b) as seen in the direction of the line II-II of FIG. 1. In FIG. 6, the ball 5S is used to connect a first substrate 3a and the second substrate 4. In the radio module 1b of FIG. 6, the same components as in FIG. 2 are denoted by the same symbol and a description is omitted or simplified.

The first pads 11 disposed in the first substrate 3a include three first pads 11A, 11B, and 11C. Similarly to the first structural example, the centers of both the first pad 11B and the second pad 12B are aligned with and opposed to each other. The first pad 11B is an example of a third pad. The second pad 12B is an example of a fourth pad. It is to be noted that when the number of the second pads 12 is four, plural number of the second pads 12B may be provided. Also, when the number of the second pads 12 is five or more, plural number of the second pads 12B may be provided, or plural number of the second pads 12A and 12C may be provided.

In the first substrate 3a, the first pads 11A, 11C the first pads 11A, 11C excluding the middle pad out of the three first pads 11 are disposed so as to be closer to the first pad 11B in the middle. In this case, edges (inward edges) of the first pads 11A, 11C, nearer to the first pad 11B are opposed and aligned with edges (inward edges) of the second pads 12A, 12C, nearer to the second pad 12B.

That is, the inward edges of the first pad 11A and the first pad 11C are located at the same positions as the inward edges of the second pad 12A and the second pad 12C in the X direction. The first pads 11A, 11C are each an example of a fifth pad. The second pads 12A, 12C are each an example of a sixth pad. It is to be noted that the second substrate 4 has the same number of pads as the first substrate 3a has.

In the second structural example of FIG. 6, when the first pads 11 are connected to respective balls 5 in the first substrate 3a, the first pads 11A, 11C are disposed so as to be closer to the first pad 11B in the middle, and thus the disposed position of each ball 5S may be determined at a position nearer to the first pad 11B. Therefore, also in the second pads 12 which are larger than the first pads 11 in size, each ball 5S is disposed at a position nearer inward to the first pad 11B. In this manner, the balls 5S are positioned by the first pads 11 of the first substrate 3a in the radio module 1 (1b), and thus even when the size of the second pads 12 is large, a variation in the disposed position of each ball 5S may be controlled.

In this manner, since the first pad 11A and the first pad 11C are disposed in the first substrate 3a so as to be closer to the first pad 11B in the middle in the radio module 1b, even when the balls 5S are used, the balls 5S may be disposed nearer to the center portion of the radio module 1b. Consequently, in the radio module 1b, the spaces between the balls 5S are narrower than in the first structural example, and the ball 5B for signal is surrounded by the balls 5A, 5C for GND with a short distance. Therefore, the radio module 1b is capable of further reducing radio wave leakage from the ball 5B for signal and radiation loss and further decreasing transmission loss.

FIG. 7 is a sectional view illustrating a third structural example of a radio module 1A as seen in the direction of the line II-II of FIG. 1. In FIG. 7, balls 5X having a larger diameter than the balls 5S are used to connect a first substrate 3A and the second substrate 4. Each ball 5X has the same shape and characteristics as those of each ball 5. In FIG. 7, the same components as in FIG. 2 or FIG. 6 are denoted by the same symbol and a description is omitted or simplified.

For example, the radio module 1A has the following dimensions: the height of the RFIC 25 which is built in as an electronic component is 300 μm, the height of solder used for solder mounting is 70 μm, and the thickness of the resists 8, 9 which are applied onto the metal (for example, the first pads 11, the second pads 12) is 20 μm. The radio module 1A uses, as an example, the ball 5X having a diameter of 490 μm which is the sum of the height of the RFIC 25, the height of solder, the thickness of the resists, and 100 μm as a margin.

When the balls 5X are used, the radio module 1A is manufactured using the first substrate 3A and the second substrate 4. In the first substrate 3A, first pads 11D having a large size are disposed. The first substrate 3A is different from a substrate that uses the balls 5S having a smaller diameter than the balls 5X. The second substrate 4 is the same as the substrate that uses the balls 5S.

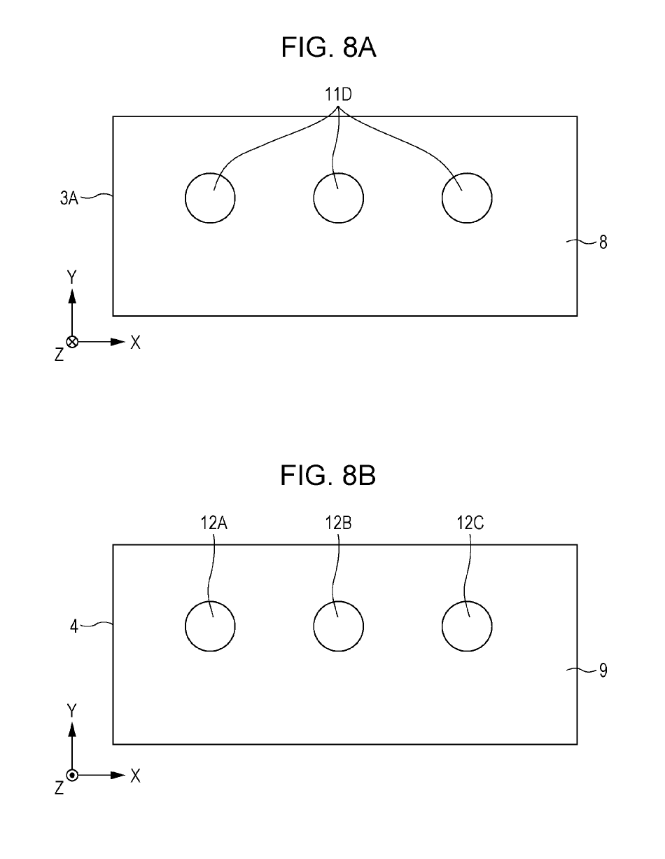

FIG. 8A is a plan view illustrating an example of the first substrate 3A and the first pads 11D. FIG. 8A is a plan view of the first substrate 3A as seen from the lower side in FIG. 7, and the first pads 11D are disposed on +Z direction side of the first substrate 3A. FIG. 8B is a plan view illustrating an example of the second substrate 4 and the second pads 12. FIG. 8B is a plan view of the second substrate 4 as seen from the upper side in FIG. 7, and the second pads 12 are disposed on −Z direction side of the second substrate 4.

The size of the first pads 11D disposed in the first substrate 3A is determined according to the size of the balls 5X, and thus is larger than the size of the first pads 11 disposed in the first substrate 3 illustrated in FIG. 3A. The size of the second pads 12A, 12B, 12C illustrated in FIG. 8B is the same as the size of the second pads 12A, 12B, 12C illustrated in FIG. 3B.

The pad sizes of the first pads 11, 11D are changed according to the sizes of balls 5S, 5X, but the size of the second pads 12 is fixed. Thus, in the radio module 1, the first substrates 3, 3A are changed in order to prepare the first pads 11, 11D in a desired size, and a common substrate may be used for the second substrate 4. The sizes of the first pads 11, 11D depend on the sizes of the balls 5S, 5X. The sizes of the balls 5S, 5X depend on the height of the electronic components (for example, the RFIC 25, the crystal oscillator 27) that are mounted in the radio modules 1, 1A. Therefore, the second substrate 4 may be used in common without being dependent on the height of electronic components.

Next, an example of manufacturing process of the radio modules 1, 1A will be described. The manufacturing process of the radio modules 1, 1A is performed by a manufacturing apparatus (not illustrated) for the radio modules 1, 1A.

The size of the balls 5S, 5X is pre-determined according to the height of the electronic components (for example, the RFIC 25, the crystal oscillator 27) that are mounted in the second substrate 4.

First, the manufacturing apparatus for the radio modules 1, 1A forms the first pads 11, 11D having a size according to the size of the balls 5S, 5X in the first substrates 3, 3A in which the antenna 21 is mounted.

Subsequently, the manufacturing apparatus for the radio modules 1, 1A disposes the balls 5S on the first pads 11, 11D which are formed in the first substrates 3, 3A, and connects the balls 5S, 5X to the first pads 11, 11D with solder by heating.

Subsequently, the manufacturing apparatus for the radio modules 1, 1A forms the second pads 12 in the second substrate 4, the second pads 12 having the same size as or a larger size than the first pads 11, 11D.

Subsequently, the manufacturing apparatus for the radio modules 1, 1A mounts electronic components (for example, the RFIC 25, the crystal oscillator 27) on the second substrate 4 in which the second pads 12 are formed.

Subsequently, the manufacturing apparatus for the radio modules 1, 1A disposes the balls 5S, 5X connected to the first pads 11, 11D on the second pads 12 formed in the second substrate 4, and connects the balls 5S, 5X to the second pads 12 with solder by heating. In this manner, the manufacturing apparatus for the radio modules 1, 1A stacks the first substrates 3, 3A on the second substrate 4 between which the electronic components are built in.

When the height of the electronic components built in between the substrates is low and the balls 5S are used, the size of the first pads 11 formed in the first substrate 3 is smaller compared with the size of the second pads 12 formed in the second substrate 4.

On the other hand, when the height of the electronic components built in between the substrates is high and the balls 5X are used, the size of the second pads 12 formed in the second substrate 4 is the same as the size of the first pads 11 formed in the first substrate 3A.

In this manner, in the radio module 1, ball 5D is positioned by the first pads 11 disposed in the first substrate 3 that are smaller in size than the second pads 12 disposed in the second substrate 4. Consequently, a variation in the disposed positions of the balls 5S interposed between the first pads 11 and the second pads 12 may be controlled.

Also, even when the sizes of the balls 5S, 5X are changed according to the height of the electronic components built in between the substrates in the radio modules 1, 1A, the radio modules 1, 1A may be manufactured by changing the first substrates 3, 3A but not changing the second substrate 4. In this manner, the second substrate 4 including the built-in electronic components may be used in common, thereby providing the radio modules 1, 1A having high general versatility. Consequently, the manufacturing cost of the radio modules 1, 1A may be reduced.

In the radio module 1b, the balls 5S may be disposed to be closer to the center portion by using the first substrate 3a in which the first pad 11A and the first pad 11C are disposed to be closer to the first pad 11B in the middle. Therefore, the spaces between the balls 5S may be narrowed, and radiation loss may be further reduced.

In addition, even when high frequency signals are used, for example, between the antenna 21 mounted in the first substrate 3a and the electronic components mounted in the second substrate 4, the balls 5S allow radio communication to be performed with reduced transmission loss.

Also, by using metal for the body of each ball 5S, the body is not easily melted by heat, and the shape of the ball 5S is maintained and the disposed positions of the balls 5S with respect to the first pads 11 and/or the second pads 12 may be further stabilized.

### Second Embodiment

In the first embodiment, the circular-shaped second pads included in the radio module have been illustrated. In the second embodiment, it is assumed that a radio module includes the second pads having a teardrop shape.

Because the radio module in the second embodiment has the same configuration as the radio module in the first embodiment, the same components as in the first embodiment are denoted by the same symbol and a description is omitted or simplified.

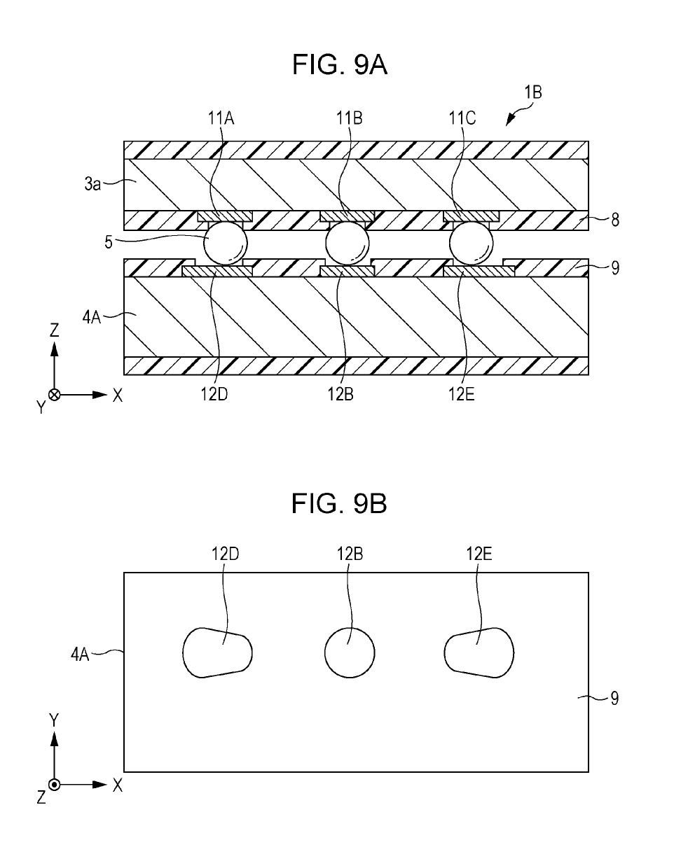

FIG. 9A is a sectional view illustrating a structural example of a radio module 1B. FIG. 9A illustrates the structure of the radio module 1B, which is similar to FIG. 6. FIG. 9B illustrates a second substrate 4A as seen in +Z direction of FIG. 9A.

In the second substrate 4A, the second pad 12B for signal and the second pads 12D, 12E adjacent to the second pad 12B are disposed. Similarly to the first embodiment, the second pad 12B for signal has a circular shape. The second pads 12D, 12E for GND have an outline shape that tapers down toward the second pad 12B for signal. In other words, the second pads 12D, 12E for GND has a teardrop shape as if a drop falls from the second pad 12B.

The teardrop shape is an example of shape which extends toward the second pad 12B disposed in the middle out of the second pads, and which has a smaller area as the shape is closer to the second pad 12B.

In the radio module 1B, the second pads 12D, 12E of the second substrate 4A are in a teardrop shape, and thus when the height of the electronic components built in between the substrates is low and relatively small balls 5 are used, the firs substrate 3a is used. Consequently, in the radio module 1B, the balls 5S may be disposed to be closer to the side (also referred to as the second pad 12B for signal side, or edge side) of narrow portion of each teardrop shape of the second substrate 4A and may be fixed by the first pads 11A, 11B, 11C of the first substrate 3a.

Therefore, the radio module 1B achieves reduced space between the ball 5B for signal connected to the second pad 12B in the middle, and the balls 5A, 5C for GND connected to the second pads 12D, 12E other than the middle. In the radio module 1B, the space between the second pad 12B in the middle and the teardrop-shaped second pads 12D, 12E may be reduced compared with the case where the circular second pads 12 are used, and thus transmission loss, which occurs when a signal (for example, a high frequency signal) transmits through the ball 5B, may be further reduced.

On the other hand, when the ball 5X having a larger diameter than the ball 5S is used in the radio module 1B, the first substrate 3A is used. Thus, in the radio module 1B, the balls 5X may be disposed to be closer to the side (on the opposite side to the second pad 12B for signal) of larger portion of each teardrop shape of the second substrate 4A, and may be fixed by the first pads 11A, 11B, 11C of the first substrate 3A.

Therefore, even when the ball 5X is used, the second substrate 4A does not have to be replaced in the radio module 1B. Consequently, the radio module 1B allows the second substrate 4A to be used in common irrespective of the use of the ball 5S or 5X.

In this manner, in the radio module 1B, each ball 5S may be easily disposed to be closer to the center portion also by the second substrate 4A in addition to by the first substrate 3a, and positioning of each ball 5S with respect to the first pads 11 and the second pads 12B, 12D, 12E may be easily made. Therefore, probability of reduction in transmission loss in the radio module 1B may be improved.

In the present embodiment, similarly to FIG. 6, it has been illustrated that the first pads 11A, 11C excluding the middle pad out of the three first pads 11 disposed in the first substrate 3a are disposed to be closer to the first pad 11B in the middle. In the present embodiment, similarly to the first substrate 3 of FIG. 2, the first pads 11A, 11C excluding the middle pad are not disposed to be closer to the first pad 11B in the middle, and the center portion of each first pad 11 in the X direction may be disposed to be opposed to the center portion of each second pad in the X direction.

### Third Embodiment

In the second embodiment, it has been illustrated that the two second pads for GND have a teardrop shape. In a third embodiment, a case will be described in which the second pad for signal in the middle also has a teardrop shape.

Because the radio module in the third embodiment has the same configuration as the radio module in the first embodiment, the same components as in the first embodiment are denoted by the same symbol and a description is omitted or simplified.

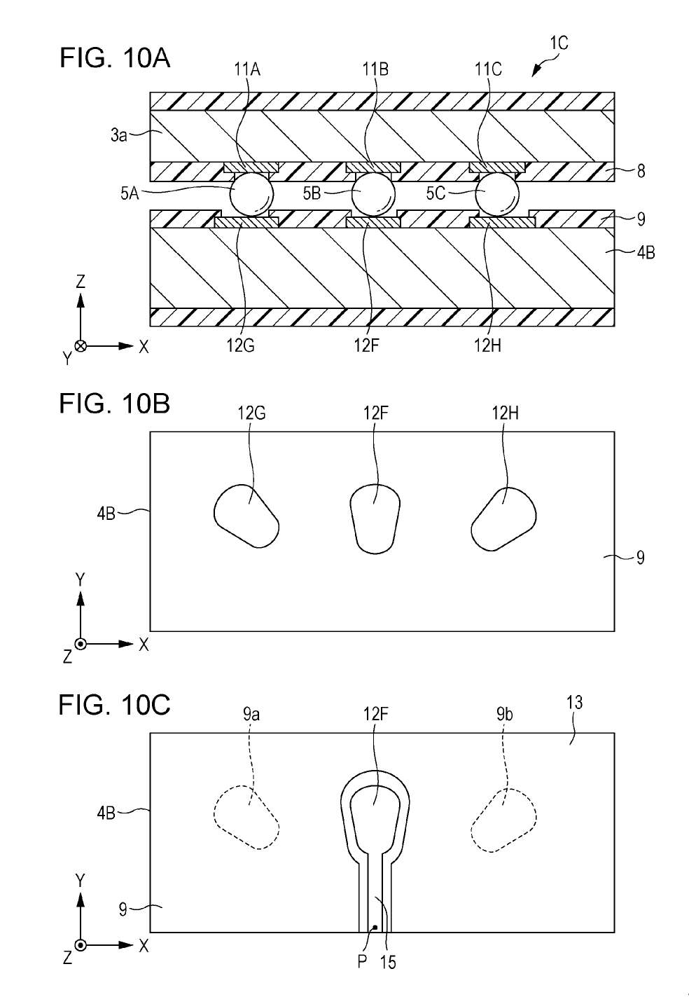

FIG. 10A is a sectional view illustrating a structural example of a radio module 1C, similarly to FIG. 6. FIG. 10B is a plan view illustrating a second substrate 4B as seen from the upper side of the radio module 1C of FIG. 10A, that is, in +Z direction. FIG. 10C is a translucent view of the second substrate 4B in a state where the resists are removed and a metal 13 serving as GND is exposed in the radio module 1C of FIG. 10B.

In FIG. 10C, the second substrate 4B is covered by the metal 13 serving as GND so as to surround the second pad 12F for signal. The dotted line in FIG. 10C indicates resist openings 9a, 9b at which the second pads 12G, 12H for GND are exposed, where the second substrate 4B is covered by the resist 9.

In FIG. 10C, the second pad 12F for signal, and the second pads 12G, 12H for GND adjacent to the second pad 12F are disposed in the second substrate 4B. In FIG. 10C, the second pads 12F, 12G, 12H have an outline shape that tapers down toward a predetermined point P on the transmission line 15. That is, the second substrate 4B has pads in a teardrop shape as if a drop falls from the point P (see FIG. 10C). It is to be noted that for example, the terminal of the RFIC 25 is located at the point P.

The teardrop shape is an example of shape which extends toward the predetermined point P and which has a smaller area as the shape is closer to the predetermined point P.

In the radio module 1C, when the height of the electronic components built in between the substrates is low and the balls 5S having a smaller diameter than the balls 5X are used, the space between the ball 5B for signal and the balls 5A, 5C, 5D for GND may be narrowed using the first substrate 3a and the second substrate 4B. In the radio module 1C, the space between the predetermined point P and the teardrop-shaped second pads 12F, 12G, 12H may be reduced compared with the case where the circular second pads 12 are used, and thus transmission loss, which occurs when a signal (for example, a high frequency signal) is transmitted at the point P, may be further reduced.

That is, loss of radiation from the predetermined point P may be reduced in the radio module 1C because the balls 5S are densely disposed around the predetermined point p. In addition, transmission distance of signals may be shortened and transmission loss may be reduced in the radio module 1C by disposing each ball 5S closer in the direction of the tip of the teardrop shape and adjusting the tip direction to a signal transmission direction.

On the other hand, when relatively large ball 5X is used in the radio module 1C, the first substrate 3A is used. Thus, in the radio module 1C, the balls 5X may be disposed to be opposed to the first pads 11A, 11B, 11C of the first substrate 3 and to be closer to the side (on the opposite side to the second pad 12F for signal) of larger portion of each teardrop shape in the second substrate 4B.

Therefore, even when relatively large ball 5X is used in the radio module 1C, the second substrate 4A does not have to be replaced. Consequently, the radio module 1C allows the second substrate 4A to be used in common irrespective of the use of the ball 5S or 5X.

In the radio module 1C, each ball 5S may be easily disposed to be closer to a predetermined point by the first substrate 3a and the second substrate 4B, and positioning of each ball 5S with respect to the first pads 11 and the second pads 12F, 12G, 12H may be easily made. Therefore, loss of transmission of signal at the predetermined point may be reduced.

In the present embodiment, similarly to FIG. 6, it has been illustrated that the first pads 11A, 11C excluding the middle pad out of the three first pads 11 disposed in the first substrate 3a are disposed to be closer to the first pad 11B in the middle. In the present embodiment, similarly to the first substrate 3 of FIG. 2, the first pads 11A, 11C excluding the middle pad are not disposed to be closer to the first pad 11B in the middle, and the center portion of each first pad 11 in the X direction may be disposed to be opposed to the center portion of each second pad in the X direction.

Various embodiments have been described with reference to the accompanying drawings in the above. Needless to say, the present disclosure is not limited to those examples. It is apparent that various modifications and alterations will occur to those skilled in the art within the scope of the appended claims, and it should be understood that those modifications and alterations naturally fall within the technical scope of the present disclosure. In a range without departing from the spirit of the present disclosure, the components in the above embodiments may be combined in any manner.

For example, in the above embodiments, the case has been illustrated in which the RFIC 25 and the crystal oscillator 27 are mounted as an example of electronic components. However, other ICs or electronic components may be mounted.

### Outline of an Aspect of the Present Disclosure

A first aspect of the present disclosure provides a radio module including: a first substrate; a second substrate that has a side which is opposed to the first substrate and on which an electronic component is mounted; a conductive member that connects the first substrate and the second substrate and that transmits a signal between the first substrate and the second; at least one first pad that is disposed in the first substrate and connected to the conductive member; and at least one second pad that is disposed in the second substrate and connected to the conductive member, each of the at least one second pad being opposed to each of the at least one first pad and larger than each of the at least one first pad in area.

A second aspect of the present disclosure provides the radio module according to the first aspect, in which the at least one first pad comprises plural first pads and is disposed in the first substrate, the at least one second pad comprises plural second pads and is disposed in the second substrate, the first pads include at least one third pad and at least one fifth pad adjacent to the at least one third pad, the second pads include at least one fourth pad and at least one sixth pad adjacent to the at least one fourth pad, each of the at least one third pad has a center that is aligned with and opposed to a center of a corresponding one of the at least one fourth pad, and each of the at least one fifth pad has an edge adjacent to the at least one third pad is aligned with and opposed to an edge of a corresponding one of the at least one sixth pad adjacent to the at least one fourth pad.

A third aspect of the present disclosure provides the radio module according to the first aspect, in which the at least one first pad comprises plural first pads and is disposed in the first substrate, the at least one second pad comprises plural second pads and is disposed in the second substrate, the second pads include at least one fourth pad and at least one sixth pad adjacent to the at least one fourth pad, and the at least one sixth has a narrower width toward the at least one fourth pad.

A fourth aspect of the present disclosure provides the radio module according to the first aspect, in which the at least one first pad comprises plural first pads and is disposed in the first substrate, the at least one second pad comprises plural second pads and is disposed in the second substrate, and the second pads each have a narrower width toward a predetermined point.

A fifth aspect of the present disclosure provides the radio module according to the first aspect, further including an antenna that is mounted in the first substrate and electrically connected to the electronic component via the conductive member.

A sixth aspect of the present disclosure provides a method of manufacturing a radio module, the method including: forming at least one first pad with a size according to a size of a conductive member in a first substrate; connecting the conductive member to the at least one first pad formed in the first substrate; forming at least one second pad in the second substrate, each of the at least one second pad having a fixed size larger than a size of each of the at least one first pad; mounting an electronic component on a side of the second substrate, the side on which the at least one second pad is formed; and connecting the conductive member to the second pad and stacking one of the first substrate and the second substrate on the other.

The present disclosure is useful for a radio module and a method of manufacturing the radio module that enable a variation in disposed position of a conductive member to be controlled and manufacturing cost to be reduced, the disposed position being with respect to a corresponding pad provided in a substrate.

What is claimed is:

1. A radio module comprising:
a first substrate;
a second substrate that has a side which is opposed to the first substrate and on which an electronic component is mounted;
a conductive member that connects the first substrate and the second substrate and that transmits a signal between the first substrate and the second;
at least one first pad that is disposed in the first substrate and connected to the conductive member; and
at least one second pad that is disposed in the second substrate and connected to the conductive member, each of the at least one second pad being opposed to each of the at least one first pad and larger than each of the at least one first pad in area.

2. The radio module according to claim 1,
wherein the at least one first pad comprises plural first pads and is disposed in the first substrate,
the at least one second pad comprises plural second pads and is disposed in the second substrate,
the first pads include at least one third pad and at least one fifth pad adjacent to the at least one third pad,
the second pads include at least one fourth pad and at least one sixth pad adjacent to the at least one fourth pad,
each of the at least one third pad has a center that is aligned with and opposed to a center of a corresponding one of the at least one fourth pad, and
each of the at least one fifth pad has an edge adjacent to the at least one third pad is aligned with and opposed to an edge of a corresponding one of the at least one sixth pad adjacent to the at least one fourth pad.

3. The radio module according to claim 1,
wherein the at least one first pad comprises plural first pads and is disposed in the first substrate,
the at least one second pad comprises plural second pads and is disposed in the second substrate,
the second pads include at least one fourth pad and at least one sixth pad adjacent to the at least one fourth pad, and
the at least one sixth has a narrower width toward the at least one fourth pad.

4. The radio module according to claim 1,
wherein the at least one first pad comprises plural first pads and is disposed in the first substrate,
the at least one second pad comprises plural second pads and is disposed in the second substrate, and
the second pads each have a narrower width toward a predetermined point.

5. The radio module according to claim 1, further comprising
an antenna that is mounted in the first substrate and electrically connected to the electronic component via the conductive member.

6. A method of manufacturing a radio module, the method comprising:
forming at least one first pad with a size according to a size of a conductive member in a first substrate;
connecting the conductive member to the at least one first pad formed in the first substrate;
forming at least one second pad in the second substrate, each of the at least one second pad having a fixed size larger than a size of each of the at least one first pad;
mounting an electronic component on a side of the second substrate, the side on which the at least one second pad is formed; and
connecting the conductive member to the second pad and stacking one of the first substrate and the second substrate on the other.
